(19) United States
(12) Patent Application Publication
(10) Pub. No.: US 2022/0305940 A1
(43) Pub. Date: Sep. 29, 2022

(54) POWER ADJUSTMENT SYSTEM AND AGGREGATION DEVICE

(71) Applicants: TOYOTA JIDOSHA KABUSHIKI KAISHA, Toyota-shi (JP); TOYOTA TSUSHO CORPORATION, Nakamura-ku (JP)

(72) Inventors: Shunsuke KOBUNA, Sunto-gun (JP); Yusuke HORII, Nagoya-shi (JP); Masato EHARA, Gotemba-shi (JP); Yukio NEZU, Ota-ku (JP); Chinatsu TAKEUCHI, Nagoya-shi (JP); Kenji YODOSE, Yokohama-shi (JP)

(73) Assignees: TOYOTA JIDOSHA KABUSHIKI KAISHA, Toyota-shi (JP); TOYOTA TSUSHO CORPORATION, Nakamura-ku (JP)

(21) Appl. No.: 17/698,359

(22) Filed: Mar. 18, 2022

(30) Foreign Application Priority Data
Mar. 25, 2021 (JP) 2021-052218

(51) Int. Cl. B60L 53/63; B60L 55/00; B60L 53/66; B60L 53/68; H02J 7/00

(52) U.S. Cl. CPC B60L 53/63; B60L 55/00; B60L 53/66; B60L 53/68; H02J 7/0068

(57) ABSTRACT

A power adjustment system adjusts charging and discharging power of a plurality of electrified vehicles in a virtual power plant that uses the electrified vehicles as energy resources. The power adjustment system includes: a first processor configured to manage charging and discharging of the electrified vehicles based on vehicle information of each individual electrified vehicle included in the electrified vehicles; and a second processor configured to control charging and discharging between the electrified vehicles and a plurality of chargers and dischargers connected to a power distribution grid based on charge and discharge information supplied from the first processor. The charge and discharge information is generated based on the vehicle information of the each individual electrified vehicle, and includes a charge and discharge constraint of an electrified vehicle group composed of the electrified vehicles and a charge and discharge constraint of the each individual electrified vehicle.

### CROSS-REFERENCE TO RELATED APPLICATION

This application claims priority to Japanese Patent Application No. 2021-052218 filed on Mar. 25, 2021, incorporated herein by reference in its entirety.

### BACKGROUND

### 1. Technical Field

The present disclosure relates to a power adjustment system that adjust charging and discharging power of a plurality of electrified vehicles in a virtual power plant (VPP) that uses the electrified vehicles as energy resources, and aggregation devices constituting such a power adjustment system.

### 2. Description of Related Art

Virtual power plants (VPPs) that use a plurality of electrified vehicles (including pure battery electric vehicles that use only a battery as an energy source, and plug-in hybrid electric vehicles) as energy resources are increasingly being studied. Japanese Patent No. 5905836 (JP 5905836 B) discloses an example of a VPP.

### SUMMARY

One of the problems for implementing a VPP is to reliably secure as many power adjustment means as possible. Electrified vehicles serving as energy resources contribute to balancing of a power distribution grid by discharging of power from batteries and charging of the batteries with surplus power. Therefore, the larger the number of electrified vehicles that are incorporated in a system of the VPP, the better. However, as the number of electrified vehicles to be managed at the same time increases, it becomes more difficult to manage them with a single system, and it becomes necessary for a plurality of aggregators to cooperate. In this case, it is required to implement appropriate charging and discharging as a whole while limiting transfer of information between the aggregators as much as possible from the standpoint of confidentiality etc.

It is an object of the present disclosure to provide a power adjustment system and an aggregation device that can use a large number of electrified vehicles as energy resources for the VPP.

An aspect of the present disclosure relates to a power adjustment system that adjusts charging and discharging power of a plurality of electrified vehicles in a virtual power plant that uses the electrified vehicles as energy resources. The power adjustment system includes: a first processor configured to manage charging and discharging of the electrified vehicles based on vehicle information of each individual electrified vehicle included in the electrified vehicles; and a second processor configured to control charging and discharging between the electrified vehicles and a plurality of chargers and dischargers connected to a power distribution grid based on charge and discharge information supplied from the first processor. The charge and discharge information is generated based on the vehicle information of the each individual electrified vehicle, and includes a charge and discharge constraint of an electrified vehicle group composed of the electrified vehicles and a charge and discharge constraint of the each individual electrified vehicle.

In the above aspect, the charge and discharge information may further include a desired state of charge of the electrified vehicle group. In the above aspect, the charge and discharge information may further include a desired state of charge of the each individual electrified vehicle. In the above aspect, the first processor may be configured to control charging and discharging between the electrified vehicles and the chargers and dischargers based on the vehicle information of the each individual electrified vehicle. In the above aspect, the second processor may be connected to a first charger and discharger group included in the chargers and dischargers, and the first processor may be connected to a second charger and discharger group included in the chargers and dischargers, the second charger and discharger group being different from the first charger and discharger group.

An aspect of the present disclosure relates to an aggregation device constituting a power adjustment system that adjusts charging and discharging power of a plurality of electrified vehicles in a virtual power plant that uses the electrified vehicles as energy resources. The aggregation device includes a processor configured to: manage charging and discharging of the electrified vehicles based on vehicle information of each individual electrified vehicle included in the electrified vehicles; and communicate with a second processor that controls charging and discharging between the electrified vehicles and a plurality of chargers and dischargers connected to a power distribution grid, and send charge and discharge information necessary for the control of charging and discharging to the second processor. The charge and discharge information is generated based on the vehicle information of the each individual electrified vehicle, and includes a charge and discharge constraint of an electrified vehicle group composed of the electrified vehicles and a charge and discharge constraint of the each individual electrified vehicle.

In the above aspect, the charge and discharge information may further include a desired state of charge of the electrified vehicle group. In the above aspect, the charge and discharge information may further include a desired state of charge of the each individual electrified vehicle. In the above aspect, the processor may be configured to further control charging and discharging between the electrified vehicles and the chargers and dischargers based on the vehicle information of the each individual electrified vehicle. Of the chargers and dischargers, the aggregation device according to the above aspect may be connected to a charger and discharger group different from a charger and discharger group to which the second processor is connected.

An aspect of the present disclosure relates to an aggregation device constituting a power adjustment system that adjusts charging and discharging power of a plurality of electrified vehicles in a virtual power plant that uses the electrified vehicles as energy resources. The aggregation device includes a processor configured to: communicate with a first processor that manages charging and discharging of the electrified vehicles, and receive charge and discharge information from the first processor; and control charging and discharging between the electrified vehicles and a plurality of chargers and dischargers connected to a power distribution grid based on the charge and discharge information. The charge and discharge information includes a charge and discharge constraint of an electrified vehicle group composed of the electrified vehicles and a charge and discharge constraint of each individual electrified vehicle included in the electrified vehicles.

In the above aspect, the charge and discharge information may further include a desired state of charge of the electrified vehicle group. In the above aspect, the charge and discharge information may further include a desired state of charge of the each individual electrified vehicle. Of the chargers and dischargers, the aggregation device according to above aspect may be connected to a charger and discharger group different from a charger and discharger group to which the first processor is connected.

In the power adjustment system according to the present disclosure, the upper aggregation device (first aggregation device), which includes a first processor, manages charging and discharging of the electrified vehicles that are used as energy resources for the VPP. The lower aggregation device (second aggregation device), which includes a second processor, controls charging and discharging between the electrified vehicles and the chargers and dischargers connected to the power distribution grid. That is, the power adjustment system according to the present disclosure has a hierarchical structure including the upper aggregation device and the lower aggregation device.

The upper aggregation device manages charging and discharging of the electrified vehicles based on the vehicle information of each individual electrified vehicle, whereas the lower aggregation device controls charging and discharging between the electrified vehicles and the chargers and dischargers based on the charge and discharge information generated based on the vehicle information of each individual electrified vehicle. The charge and discharge information is information including the charge and discharge constraint of the electrified vehicle group composed of the electrified vehicles and the charge and discharge constraint of each individual electrified vehicle. The content of the charge and discharge information is more limited than the content of the vehicle information of each individual electrified vehicle. The lower aggregation device controls charging and discharging between the electrified vehicles and the chargers and dischargers within a range that satisfies the control constraints, namely the charge and discharge constraint of the electrified vehicle group and the charge and discharge constraint of each individual electrified vehicle.

As described above, the power adjustment system according to the present disclosure includes the lower aggregation device in addition to the upper aggregation device that manages charging and discharging of the electrified vehicles, and causes the lower aggregation device to control charging and discharging between the electrified vehicles and the chargers and dischargers. The lower aggregation device can control charging and discharging of the electrified vehicles with a high degree of flexibility as long as the imposed control constraints are satisfied. According to the power adjustment system of the present disclosure configured as described above, a large number of electrified vehicles can be used as energy resources for the VPP. According to the first aggregation device and the second aggregation device of the present disclosure, it is possible to implement a power adjustment system having the above effects.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the overall configuration of a VPP according to an embodiment of the present disclosure;

FIG. 2 is a block diagram showing the configurations of an upper aggregation server and a lower aggregation server according to the embodiment of the present disclosure;

FIG. 3 shows the overview of model predictive control that is performed by the upper aggregation server according to the embodiment of the present disclosure;

FIG. 4 shows examples of an optimal solution of the SOC and an allowable SOC range set based on the optimal solution as calculated by the model predictive control;

FIG. 5 shows an example of a vehicle group desired SOC, a vehicle group SOC upper limit, and a vehicle group SOC lower limit that are included in charge and discharge information;

FIG. 6 shows an example of an individual vehicle desired SOC, an individual vehicle SOC upper limit, and an individual vehicle SOC lower limit that are included in the charge and discharge information;

FIG. 7 is a flowchart of a process that is performed by a power adjustment system of the embodiment of the present disclosure; and

FIG. 8 is a block diagram showing a modification of the configuration of the power adjustment system according to the embodiment of the present disclosure.

### DETAILED DESCRIPTION OF EMBODIMENTS

An embodiment of the present disclosure will be described below with reference to the drawings. When the number, quantity, amount, range, etc. of each element are mentioned in the following embodiment, the idea of the present disclosure is not limited to the mentioned numerical values unless otherwise specified or unless the number, quantity, amount, range, etc. of the element are obviously limited to the mentioned numerical values in principle. Structures etc. that will be described in the following embodiment are not necessarily essential to the idea of the present disclosure unless otherwise specified or unless structures etc. are obviously limited to the mentioned structures etc. in principle.

### 1. Overall Configuration of VPP

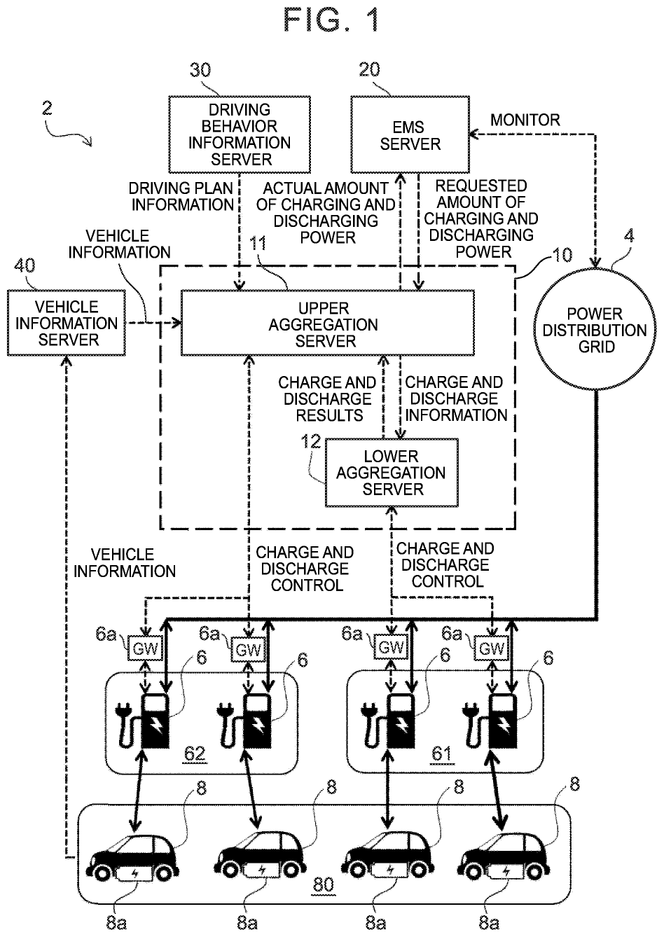

FIG. 1 shows the overall configuration of a virtual power plant (VPP) 2 of an embodiment of the present disclosure. The VPP 2 of the present embodiment is a VPP that uses a plurality of electrified vehicles 8 as energy resources. Each electrified vehicle 8 used in the VPP 2 is a vehicle including a battery 8a and a charge and discharge system. The electrified vehicles 8 includes, for example, battery electric vehicles (BEVs) and plug-in hybrid electric vehicles (PHEVs). A BEV is an electrified vehicle that runs on an electric motor using only the battery 8a as an energy source. A BEV may be equipped with a range extender. A PHEV is an electrified vehicle that includes an electric motor and an internal combustion engine, and that can directly charge from the outside the battery 8a that is an energy source of the electric motor. The electrified vehicles 8 may be a single type of electrified vehicles or a mixture of a plurality of types of electrified vehicles. The types of electrified vehicles include not only the difference between BEV and PHEV but also the difference in capacity of the battery 8a.

A plurality of chargers and dischargers 6 connected to a power distribution grid 4 is prepared in the VPP 2. The electrified vehicles 8 that serve as energy resources for the VPP 2 are connected to the power distribution grid 4 via the charger and dischargers 6. The charger and discharger 6 is used to charge the battery 8a of the electrified vehicle 8 from the power distribution grid 4 and to discharge the battery 8a of the electrified vehicle 8 to the power distribution grid 4. However, not all electrified vehicles can be connected to the power distribution grid 4. The electrified vehicles that can be connected to the power distribution grid 4 are limited to the electrified vehicles 8 of an electrified vehicle group 80 that belongs to the VPP 2.

The VPP 2 of the present embodiment includes an energy management system (EMS) server 20, a driving behavior information server 30, a vehicle information server 40, and a power adjustment system 10. The EMS server 20 is a server that constitutes an energy management system for the VPP 2. The EMS server 20 monitors the power distribution grid 4, forecasts supply and demand, and requests the power adjustment system 10 that will be described later to adjust the amount of power. The energy management system may be, for example, a factory energy management system (FEMS) for factories or a community energy management system (CEMS) for communities.

The driving behavior information server 30 is a server that manages driving behaviors of the driver of each electrified vehicle 8 of the electrified vehicle group 80. The driving behavior information server 30 records each driver's history of past driving behaviors and each driver's future driving plan. The driving plan may be registered by the driver, or may be estimated from the history of driving behaviors. The driving behavior information server 30 sends driving plan information of each electrified vehicle 8 associated with each driver to the power adjustment system 10.

The vehicle information server 40 is a server that manages vehicle information of each electrified vehicle 8 of the electrified vehicle group 80. The vehicle information includes a vehicle identification (ID) identifying each electrified vehicle 8, a current position of each electrified vehicle 8, a traveled distance of each electrified vehicle 8, and a state of charge (SOC) of the battery 8a of each electrified vehicle 8. The vehicle information server 40 individually extracts vehicle information from each electrified vehicle 8 of the electrified vehicle group 80 by mobile communication such as fourth generation (4G) or fifth generation (5G), and updates the stored vehicle information of each electrified vehicle 8 with the latest information. The vehicle information server 40 sends the updated vehicle information of each electrified vehicle 8 to the power adjustment system 10 in predetermined cycles.

The power adjustment system 10 is a system that adjusts the charging and discharging power of each electrified vehicle 8 of the electrified vehicle group 80. The power adjustment system 10 adjusts the charging and discharging power based on a request to adjust the amount of power from the EMS server 20. Specifically, when supply of power is requested from the EMS server 20 due to power shortage, the power adjustment system 10 adjusts the charging and discharging power of each electrified vehicle 8 so that the requested amount of power is discharged from the electrified vehicle group 80 to the power distribution grid 4. When storage of surplus power is requested from the EMS server 20, the power adjustment system 10 adjust the charging and discharging power of each electrified vehicle 8 so that the requested amount of power is charged from the power distribution grid 4 to the electrified vehicle group 80.

The power adjustment system 10 has a hierarchical structure including an upper aggregation server 11 and a lower aggregation server 12. In the present embodiment, a server is used as one embodiment of the upper aggregation device, and a server is used as one embodiment of the lower aggregation device. The upper aggregation server 11 and the lower aggregation server 12 are connected by a communication network including the Internet. In one example, the upper aggregation server 11 and the lower aggregation server 12 are run by different aggregators.

The upper aggregation server 11 is a server that manages charging and discharging of the electrified vehicles 8 of the electrified vehicle group 80. The EMS server 20, the driving behavior information server 30, and the vehicle information server 40 are connected to the upper aggregation server 11 by a communication network including the Internet. The upper aggregation server 11 manages the SOCs and charging or discharging amounts of the batteries 8a of the individual electrified vehicles 8 of the electrified vehicle group 80. The upper aggregation server 11 manages charging and discharging based on the vehicle information of the individual electrified vehicles 8 sent from the vehicle information server 40. The vehicle information used to manage charging and discharging includes information on the relationship between the SOC and the amount of deterioration. As will be described in detail later, the upper aggregation server 11 has a function to generate charge and discharge information based on the vehicle information of the individual electrified vehicles 8.

The lower aggregation server 12 is a server that controls charging and discharging between the electrified vehicles 8 connected to the chargers and dischargers 6 and the chargers and dischargers 6. The lower aggregation server 12 controls charging and discharging based on the charge and discharge information supplied from the upper aggregation server 11. The charge and discharge information is a command regarding charging and discharging that is sent from the upper aggregation server 11 to the lower aggregation server 12. The charge and discharge information includes a desired SOC and charge and discharge constraint of the electrified vehicle group 80 and charge and discharge constraints of the individual electrified vehicles 8. The SOC of the electrified vehicle group 80 refers to the percentage of the amount of actually charged power at a certain point in time relative to the sum of battery capacities of all the electrified vehicles 8 of the electrified vehicle group 80. The charge and discharge information may further include desired SOCs of the individual electrified vehicles 8.

The lower aggregation server 12 can control charging and discharging of the chargers and dischargers 6 that are managed by the lower aggregation server 12. Hereinafter, the group of chargers and dischargers 6 that are managed by the lower aggregation server 12 is referred to as the first charger and discharger group 61. The lower aggregation server 12 reports the results of the charge and discharge control to the upper aggregation server 11 as charge and discharge results. The charge and discharge results include the charging or discharging amount of each electrified vehicle 8 charged or discharged by the lower aggregation server 12.

The upper aggregation server 11 also has the function to control charging and discharging of the chargers and dischargers 6. However, the lower aggregation server 12 controls charging and discharging based on the charge and discharge information, whereas the upper aggregation server 11 controls charging and discharging based on the vehicle information of the individual electrified vehicles 8. The upper aggregation server 11 can control charging and discharging of the chargers and dischargers 6 that are managed by the upper aggregation server 11. Hereinafter, the group of chargers and dischargers 6 that are managed by the upper aggregation server 11 is referred to as the second charger and discharger group 62.

Each charger and discharger 6 belongs to either the first charger and discharger group 61 or the second charger and discharger group 62. Each charger and discharger 6 of the first charger and discharger group 61 is connected through a gateway (GW) 6a to the lower aggregation server 12 via a communication network including the Internet. Each charger and discharger 6 of the second charger and discharger group 62 is connected through a gateway (GW) 6a to the upper aggregation server 11 via a communication network including the Internet. Each electrified vehicle 8 of the electrified vehicle group 80 can be connected to both the charger and discharger 6 of the first charger and discharger group 61 and the charger and discharger 6 of the second charger and discharger group 62.

### 2. Details of Configuration and Functions of Power Adjustment System

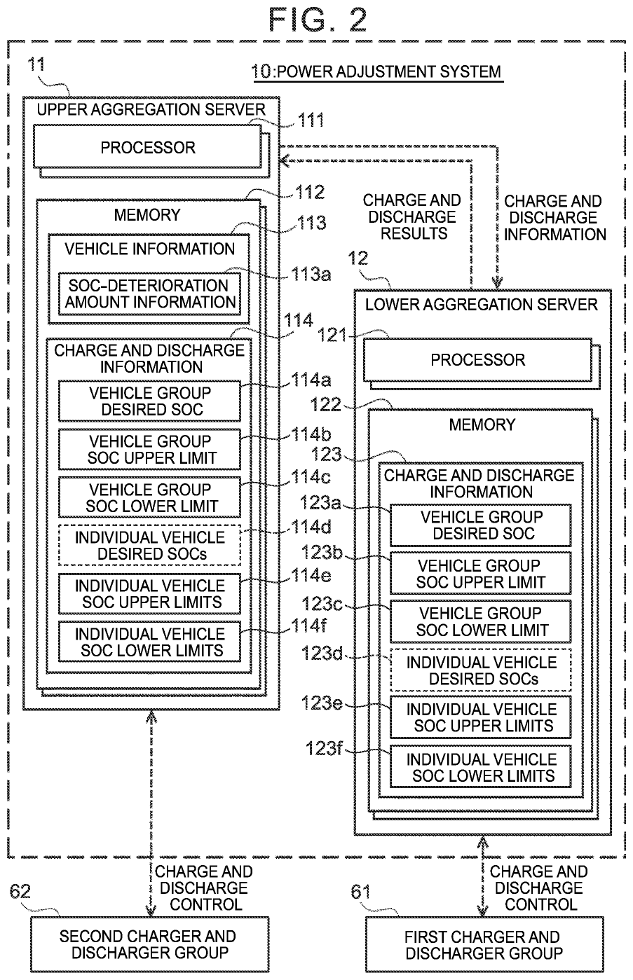

Next, the configuration and functions of the power adjustment system 10 will be described in detail. FIG. 2 is a block diagram showing the configurations of the upper aggregation server 11 and the lower aggregation server 12 that constitute the power adjustment system 10.

The upper aggregation server 11 includes one or more processors 111 (hereinafter simply referred to as the processor 111) and one or more memories 112 (hereinafter simply referred to as the memory 112) coupled to the processor 111. The memory 112 includes a main storage device and an auxiliary storage device. The memory 112 stores a program that can be executed by the processor 111 and various kinds of information related to the program. Various processes that are performed by the processor 111 are implemented by the processor 111 executing the program. The program can be stored in the main storage device or may be stored in a computer readable recording medium that is the auxiliary storage device.

The memory 112 stores vehicle information 113 and charge and discharge information 114. The vehicle information 113 exists for all of the electrified vehicles 8 of the electrified vehicle group 80, and the memory 112 stores the vehicle information 113 of each electrified vehicle 8. The vehicle information 113 includes at least SOC-deterioration amount information 113a regarding the relationship between the SOC and the amount of deterioration of the battery 8a. As described above, the charge and discharge information 114 is information generated from the vehicle information 113. The charge and discharge information 114 includes a vehicle group desired SOC 114a, a vehicle group SOC upper limit 114b, a vehicle group SOC lower limit 114c, individual vehicle SOC upper limits 114e, and individual vehicle SOC lower limits 114f. The vehicle group desired SOC 114a is a desired SOC of the electrified vehicle group 80. The vehicle group SOC upper limit 114b and the vehicle group SOC lower limit 114c are a charge and discharge constraint of the electrified vehicle group 80. The individual vehicle SOC upper limit 114e and the individual vehicle SOC lower limit 114f are a charge and discharge constraint of the individual electrified vehicle 8. The charge and discharge information 114 may include individual vehicle desired SOCs 114d. The individual vehicle desired SOCs 114d are desired SOCs of the individual electrified vehicles 8.

The lower aggregation server 12 includes one or more processors 121 (hereinafter simply referred to as the processor 121) and one or more memories 122 (hereinafter simply referred to as the memory 122) coupled to the processor 121. The memory 122 includes a main storage device and an auxiliary storage device. The memory 122 stores a program that can be executed by the processor 121 and various kinds of information related to the program. Various processes that are performed by the processor 121 are implemented by the processor 121 executing the program. The program can be stored in the main storage device or may be stored in a computer readable recording medium that is the auxiliary storage device.

The memory 122 stores charge and discharge information 123. In other words, the memory 122 does not store vehicle information but stores only the charge and discharge information 123. The charge and discharge information 123 stored in the memory 122 is the charge and discharge information 114 sent from the upper aggregation server 11. The upper aggregation server 11 sends the charge and discharge information 114 stored in the memory 112 to the lower aggregation server 12 in predetermined cycles and updates the charge and discharge information 114 stored in the memory 112 in predetermined cycles. The lower aggregation server 12 updates the charge and discharge information 123 stored in the memory 122 with the charge and discharge information 114 sent from the upper aggregation server 11. The charge and discharge information 123 includes a vehicle group desired SOC 123a, a vehicle group SOC upper limit 123b, a vehicle group SOC lower limit 123c, individual vehicle SOC upper limits 123e, and individual vehicle SOC lower limits 123f. When the charge and discharge information 114 includes the individual vehicle desired SOCs 114d, the charge and discharge information 123 also includes individual vehicle desired SOCs 123d.

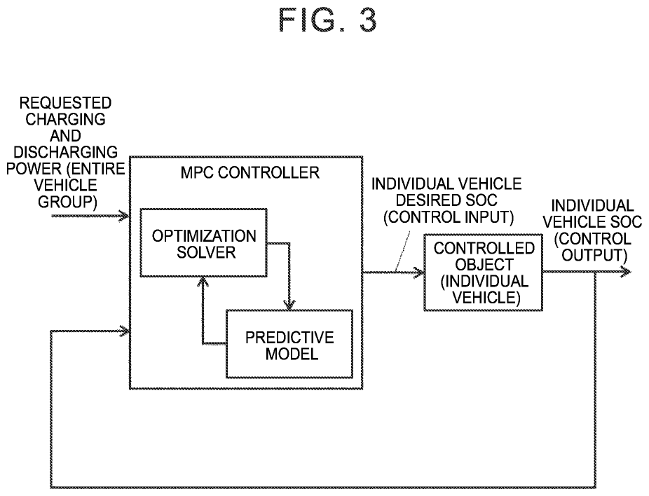

When generating the charge and discharge information 114, the upper aggregation server 11 first calculates the desired SOCs of the individual electrified vehicles 8, namely the individual vehicle desired SOCs 114d. For example, a model predictive control controller (MPC controller) is used to calculate the individual vehicle desired SOCs 114d. FIG. 3 shows the overview of model predictive control that is performed by the upper aggregation server 11. The MPC controller includes a predictive model and an optimization solver. The predictive model predicts the behavior of the SOC and the behavior of the deteriorated state of the battery 8a for a predetermined time period from the current time (prediction horizon). The optimization solver obtains a control input of an individual vehicle that is a controlled object, namely obtains a control input an individual electrified vehicle 8, by solving an optimization problem while satisfying constraints. The constraints include that the requested charging and discharging power of the electrified vehicle group 80 be satisfied in addition to that the battery 8a be prevented from running out of electricity and that the battery 8a have the SOC specified by the user. The MPC controller calculates an individual vehicle desired SOC as a control input of the individual electrified vehicle 8. An individual vehicle SOC that is a control output, namely the SOC of the individual electrified vehicle 8, together with the charging and discharging power of the individual electrified vehicle 8 is fed back to the MPC controller. Although the model predictive control is used to calculate the individual vehicle desired SOCs 114d, means for calculating the individual vehicle desired SOCs 114d is not limited to the model predictive control as long as the means is model based control capable of estimating a future state and considering constraints.

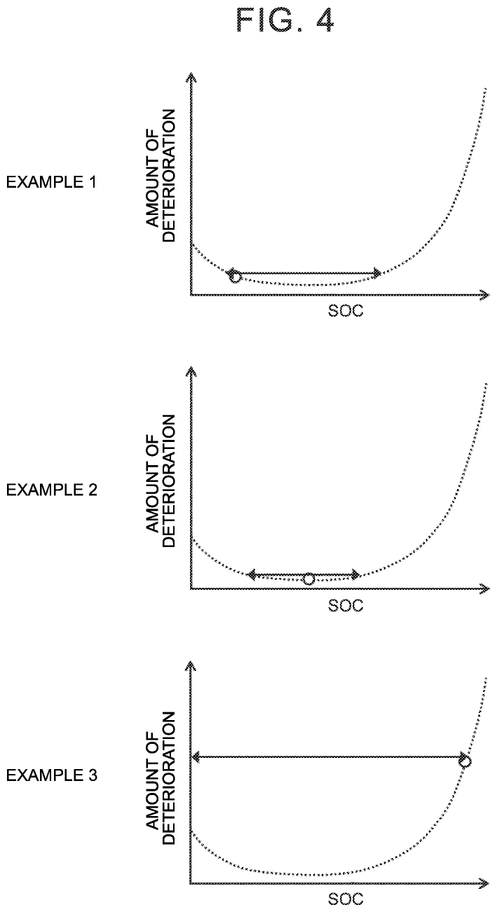

The upper aggregation server 11 calculates an allowable SOC range based on the individual vehicle desired SOC 114d that is an optimal solution of the SOC calculated by the model predictive control and the SOC-deterioration amount information 113a. The allowable SOC range is the range of SOC allowed from the standpoint of deterioration of the battery 8a. The upper limit of the allowable SOC range is the individual vehicle SOC upper limit 114e, and the lower limit of the allowable SOC range is the individual vehicle SOC lower limit 114f. FIG. 4 shows examples of an optimal solution of the SOC and an allowable SOC range set based on the optimal solution as calculated by the model predictive control.

The graph of each example shown in FIG. 4 shows the content of the SOC-deterioration amount information 113a. The abscissa of each graph represents the SOC of the battery, and the ordinate of each graph represents the amount of deterioration in capacity of the battery. In each graph, an example of the relationship between the SOC and the amount of deterioration is shown by a dotted line. The relationship between the SOC and the amount of deterioration shown by the dotted line is the SOC-deterioration amount information 113a. The relationship between the SOC and the amount of deterioration is different for each battery depending on the usage history, usage environment, individual differences of the battery 8a, etc. The SOC-deterioration amount information 113a is therefore different for each electrified vehicle 8. In each graph, the optimum solution of the SOC is shown by a circle, and the allowable SOC range is shown by a double-headed arrow. The allowable SOC range is set to the range in which the rate of increase in amount of deterioration with respect to the amount of deterioration at the optimal solution of the SOC is an allowable value (e.g., 1%) or less.

Examples 1 to 3 will be briefly described. In Example 1, the optimum solution of the SOC is lower than the SOC at which the amount of deterioration is minimum (minimum deterioration amount SOC). In this case, as the SOC becomes lower than the optimum solution of the SOC, the amount of deterioration increases and the rate of increase in amount of deterioration quickly reaches the allowable value. On the other hand, as the SOC becomes higher than the optimum solution of the SOC, the amount of deterioration decreases. As the SOC further increases and becomes higher than the minimum deterioration amount SOC, the amount of deterioration increases and eventually reaches the allowable value. That is, in Example 1, there is almost no margin for a negative deviation of the SOC from the optimal solution of the SOC, but there is a margin for a positive deviation of the SOC from the optimal solution of the SOC.

In Example 2, the optimal solution of the SOC is the minimum deterioration amount SOC. In this case, as the SOC becomes lower than the optimum solution of the SOC, the amount of deterioration increases and the rate of increase in amount of deterioration eventually reaches the allowable value. As the SOC becomes higher than the optimum solution of the SOC, the amount of deterioration also increases and the rate of increase in amount of deterioration eventually reaches the allowable value. That is, in Example 2, there is a certain amount of margin for a negative deviation of the SOC from the optimal solution of the SOC, and there is also a certain amount of margin for a positive deviation of the SOC from the optimal solution of the SOC.

In Example 3, the optimal solution of the SOC is higher than the minimum deterioration amount SOC. The SOC-deterioration amount characteristics illustrated in FIG. 4 are characteristics in which the amount of deterioration increases sharply as the SOC becomes high. Accordingly, as the SOC becomes higher than the optimal solution of the SOC, the amount of deterioration increases sharply and the rate of increase in amount of deterioration quickly reaches the allowable value. On the other hand, as the SOC becomes lower than the optimal solution of the SOC, the amount of deterioration decreases. As the SOC further decreases and becomes lower than the minimum deterioration amount SOC, the amount of deterioration increases but is kept lower than the amount of deterioration at the optimal solution of the SOC. That is, in Example 3, there is almost no margin for a positive deviation of the SOC from the optimal solution of the SOC, but there is a sufficient margin for a negative deviation of the SOC from the optimal solution of the SOC.

The upper aggregation server 11 calculates the vehicle group desired SOC 114a, the vehicle group SOC upper limit 114b, and the vehicle group SOC lower limit 114c based on the individual vehicle desired SOCs 114d, individual vehicle SOC upper limits 114e, and individual vehicle SOC lower limits 114f calculated for the individual electrified vehicles 8. The vehicle group desired SOC 114a is calculated as an average of the individual vehicle desired SOCs 114d of all the electrified vehicles 8 of the electrified vehicle group 80. The vehicle group SOC upper limit 114b is calculated as an average of the individual vehicle SOC upper limits 114e of all the electrified vehicles 8 of the electrified vehicle group 80. The vehicle group SOC lower limit 114c is calculated as an average of the individual vehicle SOC lower limits 114f of all the electrified vehicles 8 of the electrified vehicle group 80.

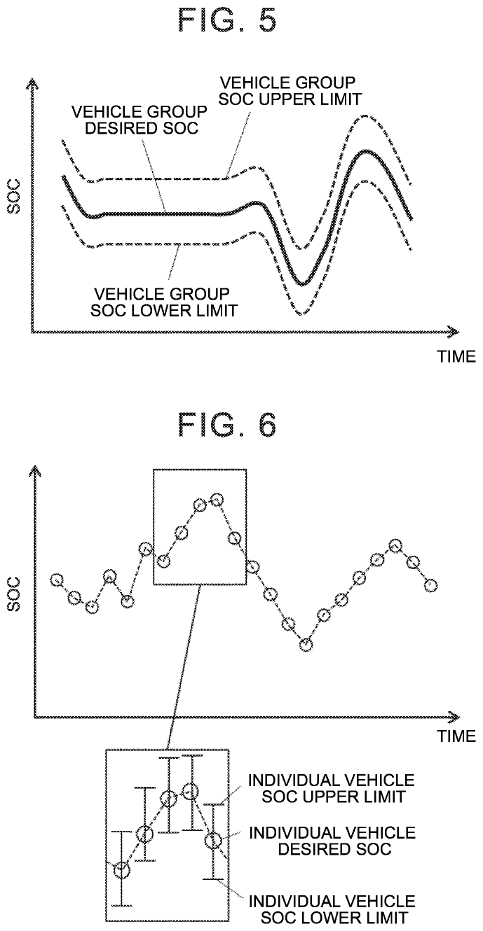

FIG. 5 shows an example of the vehicle group desired SOC, vehicle group SOC upper limit, and vehicle group SOC lower limit included in the charge and discharge information that is sent from the upper aggregation server 11 to the lower aggregation server 12. As shown in FIG. 5, the vehicle group desired SOC, the vehicle group SOC upper limit, and the vehicle group SOC lower limit are variables that change with time. The upper aggregation server 11 sends these numerical values to the lower aggregation server 12 at predetermined time intervals.

FIG. 6 shows an example of the individual vehicle desired SOC, individual vehicle SOC upper limit, and individual vehicle SOC lower limit included in the charge and discharge information that is sent from the upper aggregation server 11 to the lower aggregation server 12. As shown in FIG. 6, the individual vehicle desired SOC, the individual vehicle SOC upper limit, and the individual vehicle SOC lower limit are variables that change with time. The upper aggregation server 11 sends these numerical values to the lower aggregation server 12 at predetermined time intervals. However, as described above, sending the individual vehicle desired SOCs is optional, and the charge and discharge information does not necessarily include the individual vehicle desired SOCs.

The lower aggregation server 12 controls charging and discharging of the electrified vehicles 8 connected to the chargers and dischargers 6 of the first charger and discharger group 61 so as to control the overall SOC toward the vehicle group desired SOC 123a while keeping the overall SOC within the range from the vehicle group SOC upper limit 123b to the vehicle group SOC lower limit 123c. The lower aggregation server 12 also controls charging and discharging of the individual electrified vehicles 8 so as to keep the SOC of each individual electrified vehicle 8 within the range from its individual vehicle SOC upper limit 123e to its individual vehicle SOC lower limit 123f. When the charge and discharge information includes the individual vehicle desired SOCs 123d, the lower aggregation server 12 controls charging and discharging of the individual electrified vehicles 8 so as to control the SOC of each individual electrified vehicle 8 toward its individual vehicle desired SOC 123d while keeping the SOC of each individual electrified vehicle 8 within the range from its individual vehicle SOC upper limit 123e to its individual vehicle SOC lower limit 123f.

When the upper aggregation server 11 controls charging and discharging, the upper aggregation server 11 performs the charge and discharge control based on the vehicle information 113 of the individual electrified vehicles 8. The vehicle information 113 used in this charge and discharge control includes at least the SOC-deterioration amount information 113a and the individual vehicle desired SOC 114d. By controlling charging and discharging of each individual electrified vehicle 8 based on the SOC-deterioration amount information 113a, the SOC of the individual electrified vehicle 8 can be accurately controlled toward its individual vehicle desired SOC 123d while preventing the battery 8a from deteriorating rapidly and from becoming fully charged or running out of electricity.

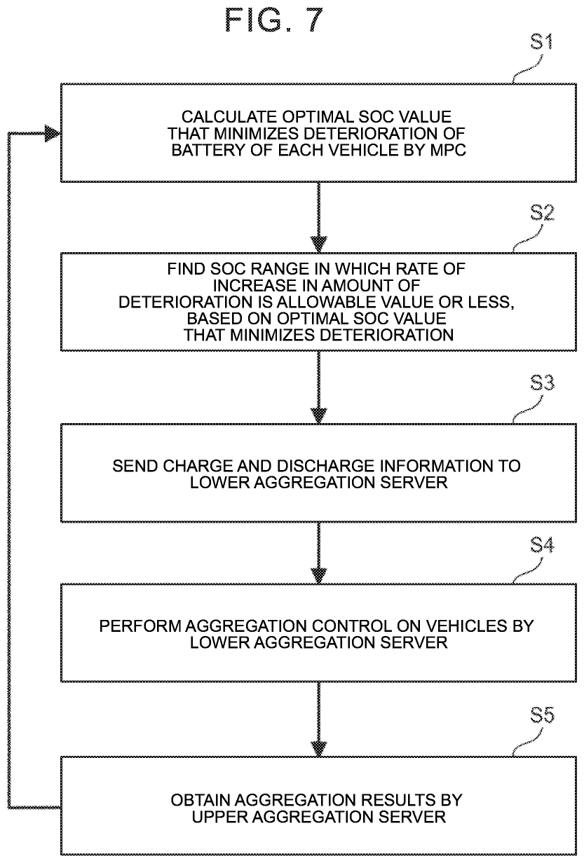

FIG. 7 is a flowchart of a process that is performed by the power adjustment system 10 having the above configuration and functions. Five steps S1 to S5 are shown in the flowchart. The power adjustment system 10 repeatedly performs these steps S1 to S5 in this order.

In step S1, the upper aggregation server 11 calculates an optimal SOC value that minimizes deterioration of the battery 8a of each electrified vehicle 8 by the model predictive control (MPC). The method for calculating the optimal SOC value by the model predictive control is as described above with reference to FIG. 3.

In step S2, the upper aggregation server 11 finds for each electrified vehicle 8 the SOC range in which the rate of increase in amount of deterioration is the allowable value or less, namely the allowable SOC range, based on the optimal SOC value. The method for finding the allowable SOC range is as described with reference to FIG. 4.

In step S3, the upper aggregation server 11 generates the charge and discharge information 114 based on the optimal SOC values calculated in step S1 and the allowable SOC ranges found in step S2. The charge and discharge information 114 includes the vehicle group desired SOC 114a, the vehicle group SOC upper limit 114b, the vehicle group SOC lower limit 114c, the individual vehicle SOC upper limits 114e, and the individual vehicle SOC lower limits 114f. The charge and discharge information 114 may include the individual vehicle desired SOCs 114d. The upper aggregation server 11 sends the charge and discharge information 114 to the lower aggregation server 12.

In step S4, the lower aggregation server 12 performs aggregation control on the electrified vehicles 8 based on the charge and discharge information 123 received from the upper aggregation server 11. The electrified vehicles 8 to be subject to the aggregation control by the lower aggregation server 12 are the electrified vehicles 8 connected to the chargers and dischargers 6 of the first charger and discharger group 61. The electrified vehicles 8 connected to the chargers and dischargers 6 of the second charger and discharger group 62 are subjected to aggregation control by the upper aggregation server 11.

In step S5, the lower aggregation server 12 reports the charge and discharge results to the upper aggregation server 11. The upper aggregation server 11 acquires the charge and discharge results reported from the lower aggregation server 12 as aggregation results. When the upper aggregation server 11 controls charging and discharging, the upper aggregation server 11 acquires the charge and discharge results of the upper aggregation server 11 itself as well as the charge and discharge results reported from the lower aggregation server 12 as the aggregation results. The upper aggregation server 11 reports the aggregation results, namely the actual values of the overall amounts of power charged and discharged to and from the electrified vehicle group 80, to the EMS server 20.

### 3. Functions and Effects of Power Adjustment System

In the power adjustment system 10 of the present embodiment, the upper aggregation server 11 manages charging and discharging of all the electrified vehicles 8 used as energy resources for the VPP 2. The upper aggregation server 11 and the lower aggregation server 12 control charging and discharging between the electrified vehicles 8 connected to the chargers and dischargers 6 and the chargers and dischargers 6.

The upper aggregation server 11 manages charging and discharging of the individual electrified vehicles 8 and controls charging and discharging of the electrified vehicles 8 connected to the chargers and dischargers 6 of the second charger and discharger group 62, based on the vehicle information 113 of each individual electrified vehicle 8. The upper aggregation server 11 controls charging and discharging so as to control the SOC of each individual electrified vehicle 8 to its individual vehicle desired SOC 114d while referring to the SOC-deterioration amount information 113a included in the vehicle information 113.

The lower aggregation server 12 controls charging and discharging of the electrified vehicles 8 connected to the chargers and dischargers 6 of the first charger and discharger group 61 based on the charge and discharge information 123 generated based on the vehicle information 113 of the individual electrified vehicles 8. The lower aggregation server 12 performs the charge and discharge control so as to achieve the vehicle group desired SOC 123a within the range that satisfies the control constraints included in the charge and discharge information 123, that is, within the range that satisfies the vehicle group SOC upper limit 123b, the vehicle group SOC lower limit 123c, the individual vehicle SOC upper limits 123e, and the individual vehicle SOC lower limits 123f.

As described above, the power adjustment system 10 includes the lower aggregation server 12 in addition to the upper aggregation server 11, and causes also the lower aggregation server 12 to control charging and discharging between the electrified vehicles 8 and the chargers and dischargers 6. The upper aggregation server 11 controls charging and discharging based on the vehicle information 113 of each individual electrified vehicle 8 including the SOC-deterioration amount information 113a. Accordingly, the overall requested charging and discharging power for the individual electrified vehicles 8 can be satisfied while minimizing deterioration of the batteries 8a of the individual electrified vehicles 8. The lower aggregation server 12 cannot use the detailed vehicle information 113 that is used by the upper aggregation server 11. However, it means that the charge and discharge control by the lower aggregation server 12 will not be restricted by the content of the vehicle information 113. That is, the lower aggregation server 12 can control charging and discharging with a high degree of flexibility as long as the imposed control constraints are satisfied.

Moreover, it is not necessary for the upper aggregation server 11 to pass the vehicle information 113 of each individual electrified vehicle 8 including the SOC-deterioration amount information 113a to the lower aggregation server 12. This is extremely advantageous when an aggregator who runs the upper aggregation server 11 and an aggregator who runs the lower aggregation server 12 are different entities. For example, when the vehicle information 113 contains highly confidential information, it is extremely disadvantageous for the aggregator who runs the upper aggregation server 11 to disclose the vehicle information 113 to the aggregator who runs the lower aggregation server 12. However, it is less disadvantageous for the aggregator who runs the upper aggregation server 11 to disclose the charge and discharge information limited to the above content to the aggregator who runs the lower aggregation server 12. Rather, the aggregator who runs the upper aggregation server 11 can incorporate the aggregator who runs the lower aggregation server 12 into VPP 2 by disclosing the minimum necessary information. This makes it possible to use more electrified vehicles 8 as energy resources for the VPP 2 than in the case where the VPP 2 is constituted only by the aggregator who runs the upper aggregation server 11.

### 4. Modification of Power Adjustment System

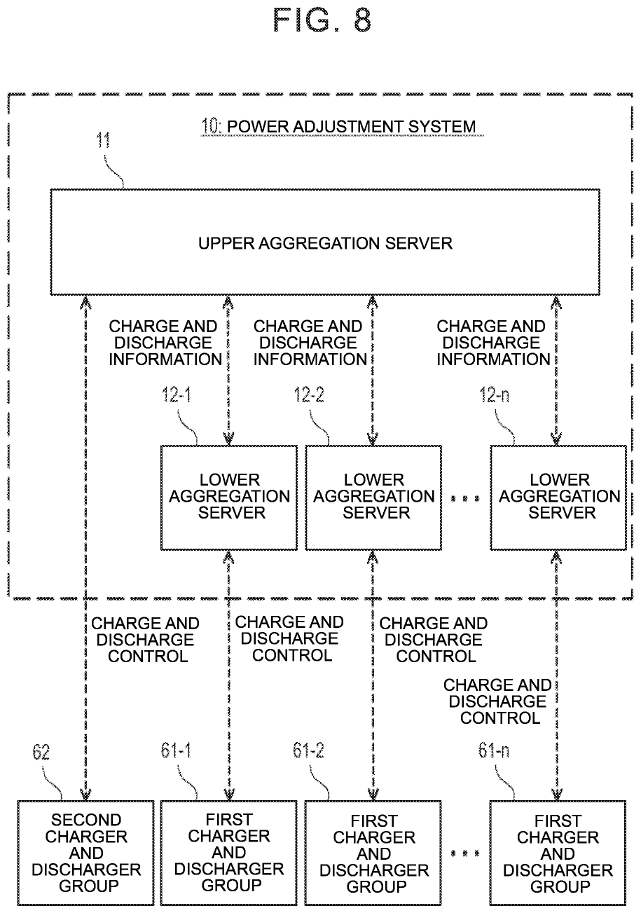

FIG. 8 is a block diagram showing a modification of the configuration of the power adjustment system 10. In the modification shown in FIG. 8, the power adjustment system 10 is composed of one upper aggregation server 11 and a plurality of lower aggregation servers 12-1, 12-2, . . . , and 12-n. These lower aggregation servers 12-1, 12-2, . . . , and 12-n may be run by different aggregators. First charger and discharger groups 61-1, 61-2, . . . , and 61-n that are independent of each other are connected to the lower aggregation servers 12-1, 12-2, . . . , and 12-n, respectively. By connecting the lower aggregation servers 12-1, 12-2, . . . , and 12-n to the upper aggregation server 11, more electrified vehicles 8 can be used as energy resources for the VPP 2.

Although not shown in the figures, the upper aggregation server 11 may be configured to only manage charging and discharging of the electrified vehicles 8. That is, the power adjustment system 10 may be configured so that the lower aggregation server(s) 12 exclusively controls charging and discharging between the electrified vehicles 8 and the chargers and dischargers 6.

What is claimed is:

1. A power adjustment system that adjusts charging and discharging power of a plurality of electrified vehicles in a virtual power plant that uses the electrified vehicles as energy resources, the power adjustment system comprising:
a first processor configured to manage charging and discharging of the electrified vehicles based on vehicle information of each individual electrified vehicle included in the electrified vehicles; and
a second processor configured to control charging and discharging between the electrified vehicles and a plurality of chargers and dischargers connected to a power distribution grid based on charge and discharge information supplied from the first processor,
wherein the charge and discharge information is generated based on the vehicle information of the each individual electrified vehicle, and includes a charge and discharge constraint of an electrified vehicle group composed of the electrified vehicles and a charge and discharge constraint of the each individual electrified vehicle.

2. The power adjustment system according to claim 1, wherein the charge and discharge information further includes a desired state of charge of the electrified vehicle group.

3. The power adjustment system according to claim 1, wherein the charge and discharge information further includes a desired state of charge of the each individual electrified vehicle.

4. The power adjustment system according to claim 1, wherein the first processor is configured to control charging and discharging between the electrified vehicles and the chargers and dischargers based on the vehicle information of the each individual electrified vehicle.

5. The power adjustment system according to claim 4, wherein:
the second processor is connected to a first charger and discharger group included in the chargers and dischargers; and
the first processor is connected to a second charger and discharger group included in the chargers and dischargers, the second charger and discharger group being different from the first charger and discharger group.

6. An aggregation device constituting a power adjustment system that adjusts charging and discharging power of a plurality of electrified vehicles in a virtual power plant that uses the electrified vehicles as energy resources, the aggregation device comprising a processor configured to:
manage charging and discharging of the electrified vehicles based on vehicle information of each individual electrified vehicle included in the electrified vehicles; and
communicate with a second processor that controls charging and discharging between the electrified vehicles and a plurality of chargers and dischargers connected to a power distribution grid, and send charge and discharge information necessary for the control of charging and discharging to the second processor,
wherein the charge and discharge information is generated based on the vehicle information of the each individual electrified vehicle, and includes a charge and discharge constraint of an electrified vehicle group composed of the electrified vehicles and a charge and discharge constraint of the each individual electrified vehicle.

7. The aggregation device according to claim 6, wherein the charge and discharge information further includes a desired state of charge of the electrified vehicle group.

8. The aggregation device according to claim 6, wherein the charge and discharge information further includes a desired state of charge of the each individual electrified vehicle.

9. The aggregation device according to claim 6, wherein the processor is configured to further control charging and discharging between the electrified vehicles and the chargers and dischargers based on the vehicle information of the each individual electrified vehicle.

10. The aggregation device according to claim 9, wherein of the chargers and dischargers, the aggregation device is connected to a charger and discharger group different from a charger and discharger group to which the second processor is connected.

11. An aggregation device constituting a power adjustment system that adjusts charging and discharging power of a plurality of electrified vehicles in a virtual power plant that uses the electrified vehicles as energy resources, the aggregation device comprising a processor configured to:
communicate with a first processor that manages charging and discharging of the electrified vehicles, and receive charge and discharge information from the first processor; and
control charging and discharging between the electrified vehicles and a plurality of chargers and dischargers connected to a power distribution grid based on the charge and discharge information,
wherein the charge and discharge information includes a charge and discharge constraint of an electrified vehicle group composed of the electrified vehicles and a charge and discharge constraint of each individual electrified vehicle included in the electrified vehicles.

12. The aggregation device according to claim 11, wherein the charge and discharge information further includes a desired state of charge of the electrified vehicle group.

13. The aggregation device according to claim 11, wherein the charge and discharge information further includes a desired state of charge of the each individual electrified vehicle.

14. The aggregation device according to claim 11, wherein of the chargers and dischargers, the aggregation device is connected to a charger and discharger group different from a charger and discharger group to which the first processor is connected.
